(19) United States
(12) Patent Application Publication
(10) Pub. No.: US 2011/0047788 A1
(43) Pub. Date: Mar. 3, 2011

(54) MANUFACTURING SYSTEM INCLUDING MODULAR ASSEMBLY STATION FOR FLEXIBLE MANUFACTURING AND OPTIONAL AUTOMATED COMPONENT PART FEED SYSTEM THEREFOR

(75) Inventors: William J. Immekus, Bloomfield Hills, MI (US); Mark Jackson, Brighton, MI (US)

(73) Assignees: DURR ECOCLEAN, INC., Auburn Hills, MI (US); DURR ECOCLEAN GMBH, Filderstadt (DE)

(21) Appl. No.: 12/840,093

(22) Filed: Jul. 20, 2010

Related U.S. Application Data
(60) Provisional application No. 61/226,917, filed on Jul. 20, 2009.
(60) Provisional application No. 61/278,849, filed on Oct. 13, 2009.

(51) Int. Cl. B23P 19/00

(52) U.S. Cl. 29/729; 29/700

(57) ABSTRACT

A manufacturing system including an apparatus in which a plurality differently configured workpieces requiring manufacturing operations are processed. The apparatus includes a work surface configured to receive apparatus components and a plurality of differently configured workpieces, a tool table adjacent the work surface providing support for tooling and apparatus components required to process various manufacturing operations on the workpieces, and a robotic manipulator positioned adjacent to the work surface and the tool table and having a gripping device configured to grip at least one of the apparatus components. Also, an automated feed system optionally included in the system for supplying component parts to the manufacturing operation. Also, a method of assembling first and second differently configured workpieces.

### CROSS-REFERENCE TO RELATED APPLICATIONS

This application claims priority to U.S. Provisional Applications Nos. 61/226,917 filed Jul. 20, 2009, and 61/278,849 filed Oct. 13, 2009, the complete disclosures of which are both incorporated herein by reference.

### BACKGROUND OF THE INVENTION

a. Field of the Invention

The invention relates to the field of modular manufacturing systems, and automated feed systems for supplying component parts thereto.

b. Description of the Related Art

Modern manufacturing has required ever-increasing complexity due to the desire to manufacture multiple products on a single assembly line. It has proven increasingly difficult to produce, for example, both V-6 and V-8 engine cylinder heads or cylinder blocks, on a single assembly line. Therefore, manufacturers of these types of products have been required to design and manufacture duplicate assembly lines, for example, one for a V-6 engine cylinder head or cylinder block, and another for a V-8 engine cylinder head or cylinder block. This has proven cost prohibitive and driven up the cost to manufacture these types of products. A particular problem is related to the variation of production volumes between different products to be manufactured. For example, full capacity production of one type of engine cylinder head or cylinder block might require 100,000 units per year, but not for several years after production of that product begins. It is cost prohibitive to prepare an entire line that will be left idle during that period due to the capital intensive requirements associated with preparing a designated manufacturing line. Additionally, when one product is phased out and another instituted, an entire assembly line can be under-utilized or sitting idle for extended periods of time. This has proven to be an unacceptable capital burden to the manufacturer of engine cylinder heads or cylinder blocks and the like.

Therefore, it has become desirable to develop a new type of mass-production manufacturing operation that can accommodate both multiple products and the variability associated with their respective production volumes.

Modern manufacturing operations have also required ever-increasing complexity due to the desire to manufacture multiple products on a single assembly line or by alternative processes. Typically, an assembly line is supplied with component parts by multiple feed systems, which include a plurality of hoppers each containing a plurality of component parts of the same type. For example, one of the hoppers contains a certain sized washer and another of the hoppers contains a certain sized screw, etc. Each of the hoppers is in communication with a dedicated conveyor for moving the component parts in single file to the assembly line. A robotic machine is in communication with each of the conveyors for properly orientating the component part and assembling it to a workpiece to complete the product. Therefore, manufacturers have required long assembly lines to accommodate the plurality of supplied component part types, each type requiring its own hopper, conveyor and robotic machine, thus taking up large amounts of space for manufacturing the products. Further, having multiple hoppers, multiple conveyors and multiple robotic machines is cost prohibitive.

Therefore, a need remains to develop an automated feed system for supplying various different component parts to an assembly operation that eliminates multiple hoppers, multiple conveyors and multiple robotic machines.

### SUMMARY OF THE INVENTION

The inventive manufacturing system includes a modular assembly station or apparatus by which workpieces of differing type or configuration may be processed, the workpieces requiring different tool operations for their production. The manufacturing system includes a work surface configured to locate and retain assembly apparatus components, and on which one of a plurality of differently configured workpieces are affixed, for processing. Assembly apparatus components may be retained to the work surface through a plurality of receptors configured to engage and affix the assembly apparatus components, and one of the plurality of differently configured workpieces, to the work surface at geometrically accurate locations. A tool table is positioned adjacent the work surface and provides support and storage for tooling and assembly apparatus components required to perform the manufacturing operation on the workpieces.

The system includes at least one robotic manipulator configured to grip at least one of the assembly apparatus components, the tooling, and one of the plurality of differently configured workpieces, and to obtain, position and assemble to the workpiece a component part. The robotic manipulator may be positioned adjacent to the work surface, the tool table, and a workpiece delivery station, and may be programmed to selectively acquire assembly apparatus components and tooling from the tool table, component parts, and the workpieces, and to perform manufacturing operations on the plurality of differently configured workpieces, such as assembling the component parts thereto.

The manufacturing system solves problems associated with conventional moving assembly lines by making it possible to conduct manufacturing operations that alter workpieces of different configurations without having to dedicate an entire assembly line to each workpiece configuration. Through use of the inventive system, only the tooling necessary for processing the various workpiece configurations is required, many of which are common to processes performed on the different workpiece configurations. The tool table can hold multiple tools and assembly apparatus components required for performing processes on differently configured workpieces. To accommodate varying demand and production volumes for different workpiece configurations, the system can selectively process and produce the different workpiece configurations using multiple tooling and assembly apparatus components with minimal redundancy, and thus provides improvements over conventional moving assembly lines.

The manufacturing system may also include an optional automated feed system for supplying a plurality of different types of component parts to the modular assembly apparatus for use in the manufacturing operation. The component part feed system includes a hopper for receiving a plurality of differently configured component parts, and a conveyor in communication with the hopper. The conveyor includes a proximal end and a distal end with the hopper disposed adjacent the proximal end. The hopper cooperates with the conveyor for moving the different types of component parts from the proximal end to the distal end.

Opposing side rails extend between the proximal and distal ends of the conveyor for guiding a potentially mixed variety of component parts from the hopper toward the distal end, at which the component parts arrive one at a time, in single file fashion. A component part robotic manipulator, movable along a track that may extend laterally relative to the direction of conveyor belt movement, is provided for acquiring the component parts individually at the conveyor distal end and relocating them away from the conveyor. An identifier is disposed adjacent the distal end for identifying the type of component part present, and determining whether the identified component part requires reorientation by the component part robotic manipulator prior to it being supplied to the manufacturing operation.

The automated component part feed system solves problems associated with prior feed systems for supplying manufacturing operations with component parts, by making it possible to process a plurality of different component parts utilizing one hopper, one conveyor and one component part robotic manipulator without having to duplicate the hoppers/conveyors/robotic manipulators for each of the different component part types needed in the manufacturing operation. The automated component part feed system reduces manufacturing costs by eliminating duplicate component part feed systems, their associated space requirements, and the need for skilled laborers to move up and down the assembly line adding a different type of component part to each of the respective, dedicated hoppers.

The present invention provides a manufacturing system including an apparatus in which a plurality differently configured workpieces requiring manufacturing operations are processed. The apparatus includes a work surface configured to receive apparatus components and a plurality of differently configured workpieces, the work surface configured to support the apparatus components and the plurality of differently configured workpiece in geometrically accurate locations. The apparatus also includes a tool table adjacent the work surface providing support for tooling and apparatus components required to process various manufacturing operations on the workpieces. The apparatus also includes a robotic manipulator positioned adjacent to the work surface and the tool table and having a gripping device configured to grip at least one of the apparatus components. At least one of apparatus components is moved by the first robotic manipulator between the tool table and the work surface, and the robotic manipulator is programmed to selectively acquire tooling from the tool table to perform manufacturing operations on the plurality of differently configured workpieces.

The present invention also provides a method of assembling first and second differently configured workpieces, including the steps of: releasably affixing first assembly apparatus components to a work surface using at least one of a plurality of receptors positioned in a geometrically accurate location; releasably affixing the first workpiece to the work surface using at least one of the plurality of receptors thereby positioning the first workpiece in a geometrically accurate location; supporting assembly apparatus components necessary to assemble the first workpiece relative to the work surface; positioning a robotic manipulator carrying tooling necessary to assemble the first workpiece and the first component part relative to the first workpiece; supporting tooling necessary to assemble the first workpiece against undesired movement relative to the first workpiece with at least one of an assembly apparatus component and the work surface; performing a first assembly operation by operating the tooling and installing the component part to the first workpiece; removing the first workpiece from the work surface; releasably affixing second assembly apparatus components to the work surface using at least one of the plurality of receptors positioned in a geometrically accurate location; releasably affixing the second workpiece to the work surface using at least one of the plurality of receptors thereby positioning the second workpiece in a geometrically accurate location; supporting assembly apparatus components necessary to assemble the first workpiece relative to the work surface; positioning a robotic manipulator carrying tooling necessary to assemble the second workpiece and a component part relative to the second workpiece; supporting tooling necessary to assemble the second workpiece against undesired movement relative to the second workpiece with at least one of an assembly apparatus component and the work surface; performing a second assembly operation by operating the tooling and installing the component part to the second workpiece; and removing the second workpiece from the work surface.

The present invention also provides an automated feed system for supplying component parts to a manufacturing operation. The feed system includes a hopper for receiving a plurality of differently configured component parts and a conveyor in communication with the hopper and having a proximal end and a distal end. The hopper is disposed adjacent the proximal end with the hopper cooperating with the conveyor for moving the component parts from the proximal end toward the distal end. Opposing side rails extend between the hopper and the conveyor distal end for guiding the component parts toward the distal end. The feed system also includes a robotic manipulator movable along a track for moving the component parts from the distal end and away from the conveyor, and an identifier disposed adjacent the distal end with the identifier in communication with the robotic manipulator, each of the component parts identified by the identifier.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is an upper perspective view of a manufacturing system including a first embodiment modular assembly station or apparatus, and an optional automated component part feed system connected thereto;

FIG. 2 is an upper perspective view of the modular assembly apparatus of FIG. 1, showing it adapted for processing a workpiece of a first type or configuration;

FIG. 3 is a view similar to FIG. 2, showing it adapted for processing a workpiece of a second, different type or configuration;

FIG. 4 is an upper perspective view of an alternative, second embodiment modular assembly station or apparatus that may instead be included in the manufacturing system of FIG. 1;

FIG. 5 is an upper perspective view of a frame for the modular assembly apparatus of FIG. 4;

FIG. 6 is an upper perspective view of the work surface and tool table associated with a subportion of the modular assembly apparatus of FIG. 4;

FIG. 7 is an upper perspective view of the modular assembly apparatus of FIG. 4, showing it adapted for processing a workpiece of a first type or configuration;

FIG. 8 is an upper perspective view of a robotic manipulator of the modular assembly apparatus of FIG. 4 moving a leak test seal plate into position on a workpiece and seal plate affixed to the work surface;

FIG. 9 is an upper perspective view of the modular assembly apparatus of FIG. 4 showing a workpiece being moved toward its fixture or adapter on the work surface;

FIG. 10 is similar to FIG. 9, but shows an anvil mounted on the work surface and a different robotic manipulator gripping device for grasping a different type of or differently configured workpiece;

FIG. 11 is a fragmentary upper perspective view of the work surface associated with the first embodiment modular assembly apparatus of FIG. 1, showing a registry attached thereto;

FIG. 12 is a view similar to FIG. 11, showing an adapter attached to the registry;

FIG. 13 is a view similar to FIG. 12, showing a workpiece attached to the adapter;

FIG. 14 is a fragmentary view of the work surface associated with the modular assembly apparatus of FIG. 1 with a workpiece mounted thereon, in place atop the adapter, and the end of the robot manipulator boom with a press ram tool head attached thereto;

FIG. 15 is a fragmentary view of the work surface associated with the modular assembly apparatus of FIG. 1 with a workpiece mounted thereon, in place atop the adapter and the end of the robot manipulator boom with a torquing tool head attached thereto;

FIG. 16 is a fragmentary view of the modular assembly apparatus of FIG. 1 showing the end of the robot manipulator boom with press ram tool head attached thereto positioned proximate to and aligned with a component part receiving station connected to the optional automated component part feed system;

FIG. 17 is an upper end view of the manufacturing system showing its optional automated component part feed system connected to its modular assembly apparatus; and

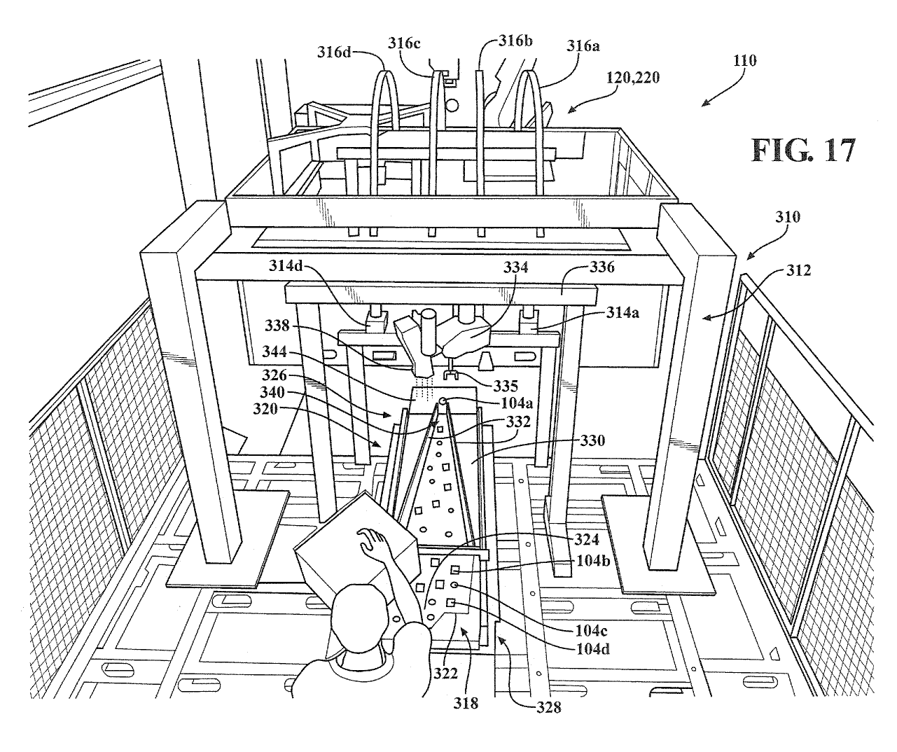

FIG. 18 is a partial, overhead view of the manufacturing system showing its optional automated component part feed system of FIGS. 1 and 17 connected to the component part receiving stations of its modular assembly apparatus.

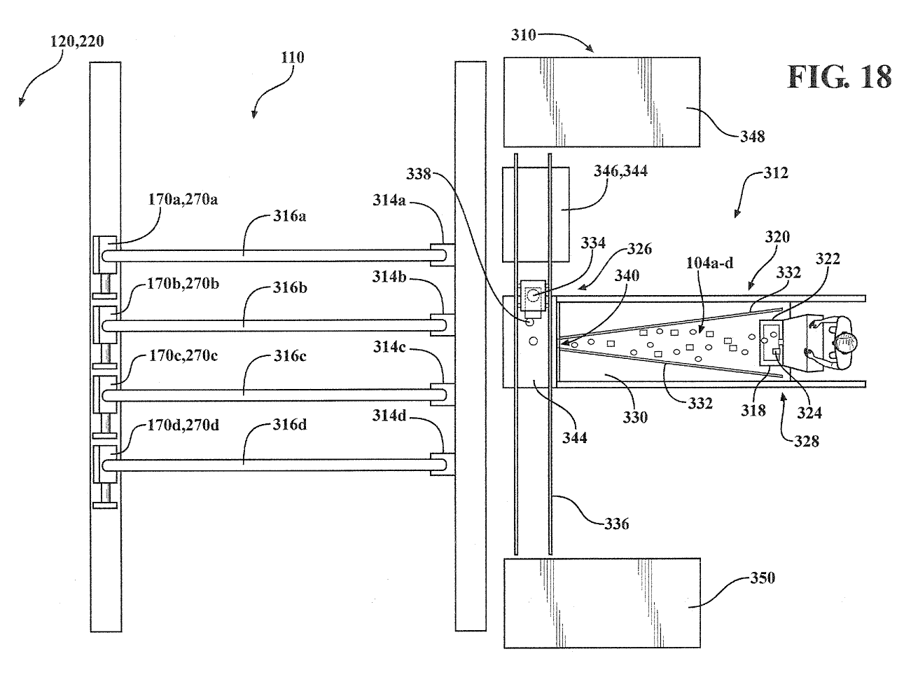

While the invention is susceptible to various modifications and alternative forms, specific embodiments thereof are shown by way of example in the drawings and may herein be described in detail. It should be understood, however, that the drawings and detailed description are not intended to limit the invention to the particular form(s) disclosed, but on the contrary, the intention is to cover all modifications, equivalents and alternatives falling within the spirit and scope of the present invention as defined by the appended claims.

### DETAILED DESCRIPTION OF EXEMPLARY EMBODIMENT(S)

The following description of the preferred embodiment(s) is merely exemplary in nature and is in no way intended to limit the invention, or its uses. It is to be noted that the figures are not necessarily drawn to scale. In particular, the scale of some of the elements of the figures may be exaggerated to emphasize characteristics of the elements. It is also noted that the figures are not drawn to the same scale. Elements shown in more than one figure that may be similarly configured have been indicated using the same reference numerals.

Disclosed herein is a flexible, modular manufacturing system by which manufacturing operations are performed on a plurality of workpieces 100 that are of different configurations or types. For example, workpieces 100 may be V8 and V6 engine blocks or cylinder heads that require various different component parts 104 to be assembled thereto. In connection with the exemplary manufacturing system embodiments discussed herein, the workpieces 100 are shown as engine cylinder heads 100a and 100b of differing, V8 and V6 configurations, respectively. It is to be understood that workpieces of different types or configurations may be processed generally as described. Each exemplary workpiece 100 has at least one component part 104 assembled thereto by manufacturing system 110. Each component part 104 may be one of a plurality of different component parts, herein identified as four different component parts 104a, 104b, 104c, and 104d that may be of differing type, size, function, attachment structure, etc. For example, component part 104a may be of a type that is interference-fitted into an aperture 106a of workpiece 100, whereas component part 104b may be of a type that is threadedly received into a threaded hole 106b in workpiece 100. Component part 104a may, for example, be a sealing plug and component part 104b may, for example, be an engine control coolant temperature sensor. The component parts 104 may also be other types of plugs or sensors, washers, screws, bolts, sprockets, gears, or any other type of component part, of any required size and configuration, suitable for a product workpiece 100 processed by manufacturing system 110.

Manufacturing system 110 includes a modular assembly apparatus or station in which a manufacturing operation is performed on the workpieces 100. In the particular example embodiments discussed herein, the manufacturing operations performed by system 110 involve assembly of at least one component part 104a, 104b, 104c, 104d to a workpiece 100a, 100b, and leak testing the assembled workpieces. Manufacturing system 110 may include first embodiment assembly apparatus 120 or second embodiment assembly apparatus 220, both described further herein below.

Generally, the first and second assembly station embodiments 120, 220 are similar in function and structure. Each has a work surface supported by a frame and to which apparatus components, such as a registry, workpiece mounting fixtures or adapters, tool-supporting anvils, and/or leak test plates, are selectively attached at geometrically accurate locations. Assembly stations 120, 220 further include a tool table on which interchangeable tooling and apparatus components are placed at respective, designated geometrically accurate locations. Assembly stations 120, 220 are provided with a supply at least one component part type, and includes at least one robotic manipulator. The component part supply of the assembly apparatus 120, 220 may include a receiving station connected to the optional automated component part feed system described further below.

A primary difference between assembly stations 120 and 220 is that assembly station 220 includes a pair of robotic manipulators which can both, or each, be utilized for setting up the work surface, which includes selecting and positioning the apparatus components and the workpiece 100, and performing the manufacturing operations, whereas assembly station 120 may include a single robotic manipulator that can perform all of these aspects of the manufacturing operation.

Tool tables 138, 238 of the respective assembly apparatuses 120, 220 support various tooling necessary to perform manufacturing operations on the differently configured workpieces 100a, 100b. Therefore, a single assembly apparatus 120 or 220 is capable of processing multiple different configurations or types of workpieces 100 without requiring duplicative assembly apparatuses. This facilitates the balancing of manufacturing flow to eliminate possible bottlenecks in a manufacturing operation.

For example, a particular manufacturing facility might receive an order for 50,000 V-8 engine cylinder heads 100a and 60,000 V-6 engine cylinder heads 100b. Alternatively, the lead time for V-8 cylinder heads 100a might be spread over six months, but the V-6 cylinder heads 100b are required for delivery within two months. A manufacturer, by making use of manufacturing system 110, can balance its production requirements by having to acquire only the additional fixtures and tooling to meet the actual, current production requirements rather than also the projected, future production requirements, and is thus not required to acquire additional entire assembly apparatuses 120, 220. The acquisition of any additional apparatuses 120, 220 can be deferred until it is necessary to actually produce higher production volumes.

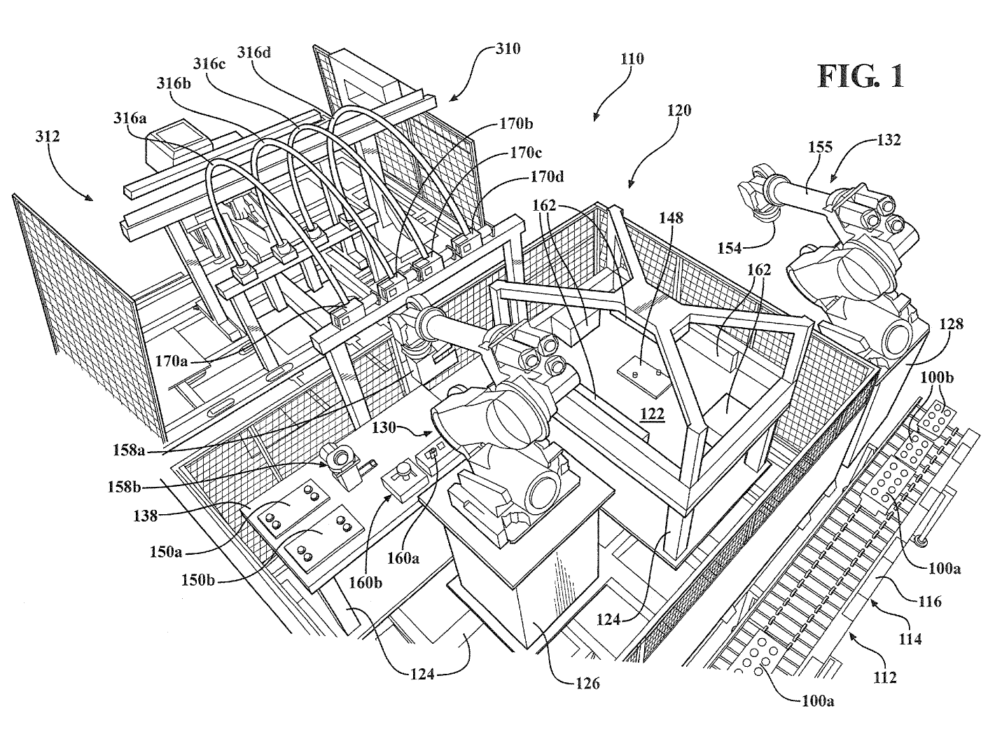

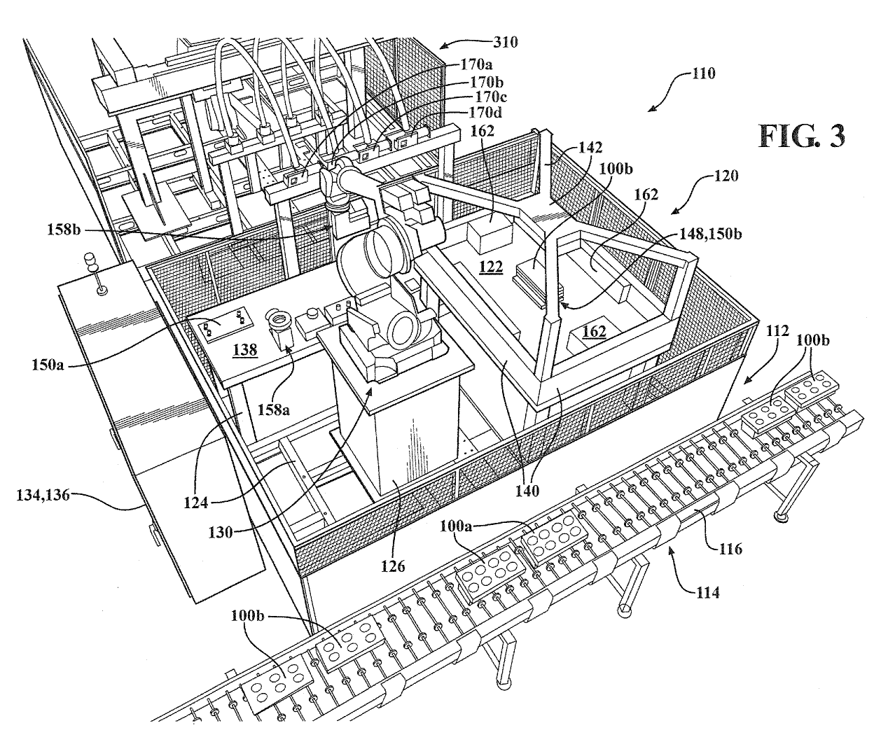

Referring to FIGS. 1-3, manufacturing system 110 may include, or be positioned adjacent to, a workpiece conveyor 112 along which the plurality of differently configured workpieces 100a, 100b are moved and from which they are supplied to the manufacturing operation. Workpiece conveyor 112 may have a position 114 therealong that defines a delivery station from which a workpiece 100 to be processed in assembly station 120, 220 is obtained by its robotic manipulator, as described above. The configuration or type of workpiece (e.g., 100a or 100b) arriving at delivery station 114 may be predefined, or recognized upon its arrival at delivery station 114 by a suitable sensor 116 such as, for example, an optical image identifier, bar code reader, magnetic code sensor, etc., all of which are known to those of ordinary skill in the art. After a workpiece 100 has completed its processing in assembly station 120, 220, its robotic manipulator may return the workpiece to delivery station 114, relocate it to another conveyance or assembly line proximate to the assembly station, or place it in nearby dunnage for transport elsewhere.

Additionally, as described further below with reference to assembly station 220, leak and/or pressure testing may be performed in assembly station 120, 220 on workpieces 100 produced by manufacturing system 110. Such testing may be performed utilizing either assembly station embodiment 120, 220 herein disclosed, which may be provided with hydraulic or pneumatic fluid pressurization capabilities, and associated pressure sensing equipment of a mechanical or electrical type.

Robot gripping device or tool head interconnection to a robotic manipulator, or assembly apparatus component interconnection to a work surface, regardless of particular embodiment, may be through use of suitable collet and balls-type changers of a type available, for example, from ATI Industrial Automation of Apex, N.C.

The assembly station 120, 220 of manufacturing system 110 may be connected to an optional automated component part feed system 310. As described below with reference to assembly station 120, component part receiving stations are positioned at geometrically accurate locations in both assembly station embodiments 120, 220, each receiving station associated with a particular one of a plurality of different types of component parts 104 supplied to the manufacturing operation. A robotic manipulator of the assembly station 120, 220 obtains with a suitable attached tool the necessary component part 104 which has been supplied by the component part feed system 310 to the respective receiving station, positions the component part relative to the workpiece 100, and assembles it to the workpiece.

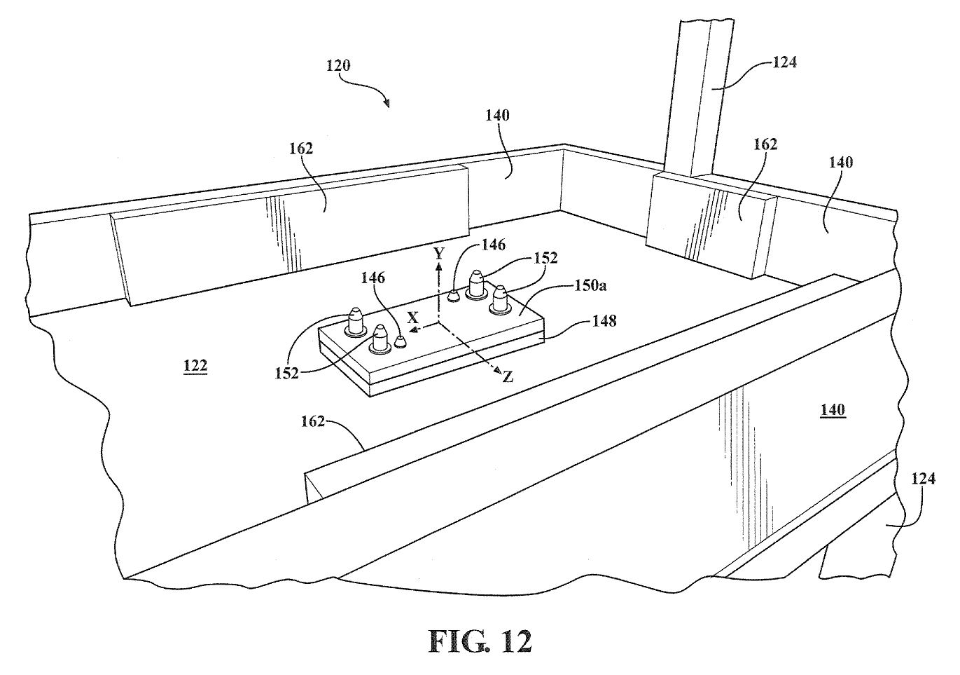

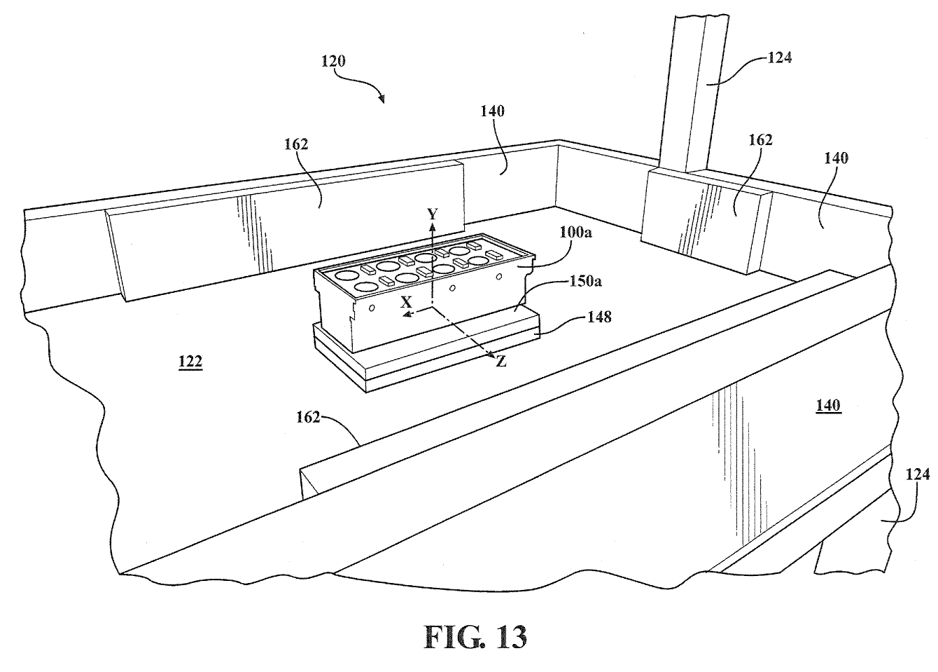

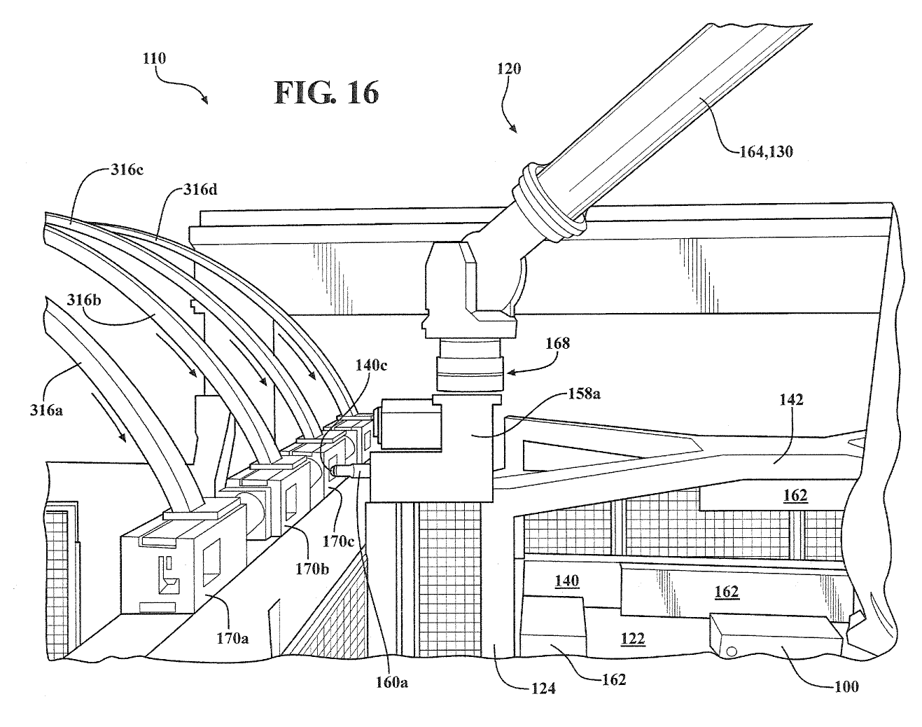

Referring to FIGS. 1-3 and 11-16, first embodiment modular assembly station or apparatus 120 of manufacturing system 110 is shown.

Modular assembly station 120 includes work surface 122 mounted upon frame 124. First and optional second manipulator platforms 126, 128 are disposed on opposite sides of and adjacent to the work surface 122. Platform 126 is also mounted to the frame 124. Optional second platform 128 may be located outside of the work cell in which work surface 122 and first manipulator platform 126 are contained, but is considered adjacent to work surface 122 with which may interact.

A first robotic manipulator 130 is mounted upon the first manipulator platform 126 and an optional second robotic manipulator 132 is mounted upon the second manipulator platform 128. Although it is contemplated that robotic manipulator 130 may carry out all robotic manufacturing operations on workpieces 100, optional second robotic manipulator 132 may be particularly useful for moving workpieces that have completed processing to a conveyance other than workpiece conveyor 112, to an assembly line, or to place the processed workpieces in dunnage for transport elsewhere. Compared to first robotic manipulator 130, optional second robotic manipulator 132 may be larger, with longer reach and higher capacity, and better suited to lifting and transferring large, heavy workpieces 100, between work surface 122 and the workpiece delivery station 114. Further, as mentioned above, it may be desirable that the workpiece 100, once its processing in assembly apparatus 120 is complete, be transferred from the work surface 122 to a location outside of the assembly station other than delivery station 114, such as another conveyance, an assembly line, or nearby dunnage for transport elsewhere; providing assembly apparatus 120 of manufacturing system 110 with optional second robotic manipulator 132 would better facilitate such transference. Robotic manipulators 130, 132 are controlled by controller 134 and electronics panel 136 in a manner well known to those of ordinary skill in the art.

A tool table 138 is also mounted on the frame 124, adjacent to the work surface 122. The tool table 138, work surface 122, and robotic manipulators 130, 132 are each arranged in a geometrically accurate location, as are component part receiving stations 170, from which component parts 104 are supplied to the manufacturing operation. Component part receiving stations 170 may be connected to optional component part feed system 310 via dispatching lanes 316.

Referring to FIGS. 1-3, frame 124 includes peripheral walls 140 that surround work surface 122, and which provide support to anvils 162 placed on work surface 122. Alternatively, anvil receptors in work surface 122 may be used for positioning and affixing anvils 162 to the work surface, in the manner described below in connection with second embodiment assembly apparatus 220. Frame 124 also includes overhead support structure 142 to which an anvil 162 is affixed. Anvils 162 present reaction surfaces that interface the workpiece and support robotic manipulator-mounted tools as they perform work on the workpiece. Any of peripheral walls 140, overhead support structure 142, and anvils 162 may be included, moved towards or away from the location of workpiece 100 as mounted on work surface 122, or omitted entirely, depending on the manufacturing operation needs.

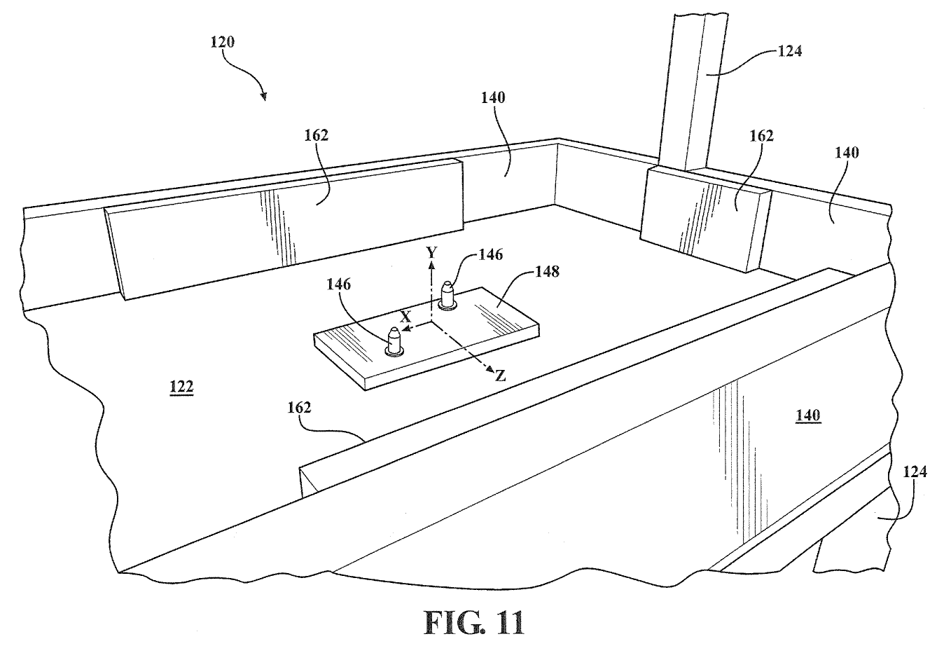

Referring to FIG. 11, registry receptors 146 extending from work surface 122 are adapted to engage the workpiece fixture registry 148 in response to pneumatic, electrical, or electronic inputs, and thereby secure the registry 148 to the work surface 122. Further, the registry 148 and registry receptors 146 may be adapted to actuate locking devices 152 of adapter 150 for engagement of the workpiece 100 in response to a mechanical, pneumatic, electrical, or electronic output from the registry 148, the output being produced in response to registry input from the receptor 146.

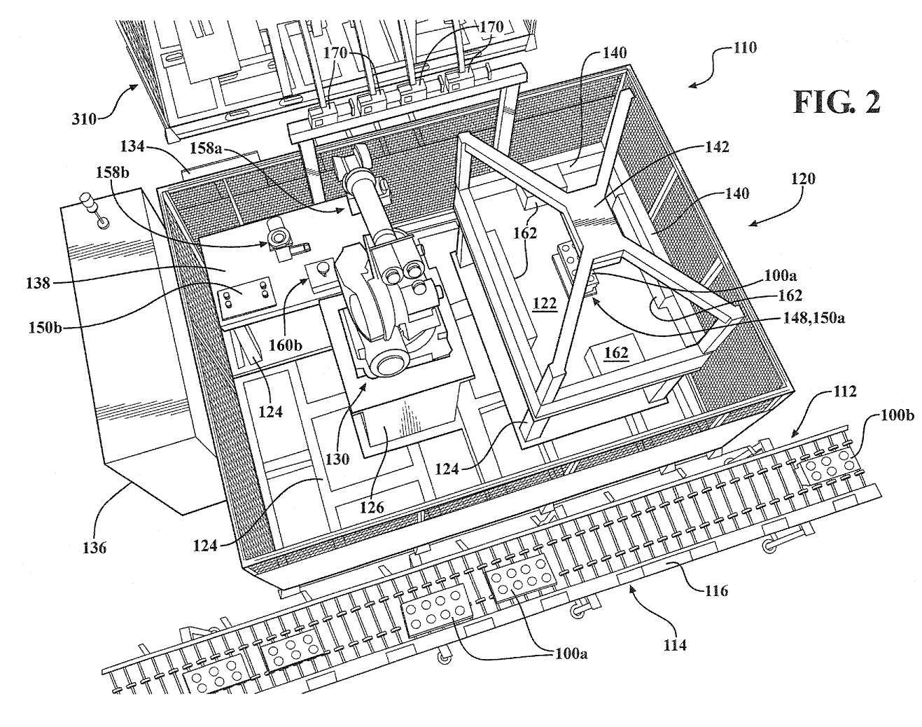

FIGS. 1 and 2 show the modular assembly apparatus 120 preparing to perform a manufacturing operation on a workpiece 100. The workpiece 100 arrives at delivery station 114 on workpiece conveyor 112 (FIG. 1), and is known to be, or is there sensed as being a particular one of the plurality of different workpiece configurations 100a, 100b. In this non-limiting example, workpiece fixtures or adapters 150a and 150b, which are particularly configured to support their respective workpieces 100a and 100b, are stored in their respective, geometrically accurate positions on tool table 138. An adapter 150 corresponding to the type or configuration of the present workpiece 100 is acquired from tool table 138 by first robotic manipulator 130 using its robotic gripper, and relocated to the work surface 122, where it is secured in a geometrically accurate location to the work surface 122 through registry 148 and registry receptors 146.

The workpiece 100 is then grasped by the first robotic manipulator 130, or by the optional second robotic manipulator 132 using its robotic gripper 154, which is removably attached to the end of the robot's boom 155. The workpiece 100 is relocated from delivery station 114 to assembly station 120, and delivered to the workpiece fixture or adapter 150 that is mounted to the work surface 122 through registry 148. In a known manner, mechanical, electronic or pneumatic inputs are provided through the work surface 122 and registry 148, to the workpiece fixture or adapter 150, to actuate locking devices 152 in the workpiece fixture or adapter 150. Locking devices 152 secure the workpiece 100 to the adapter 150, and thus to registry 148 and work surface 122, in a geometrically accurate location.

In this non-limiting example, the first robotic manipulator 130 is articulated to the tool table 138, and using its gripping device grasps one of a plurality of anvils 162, each of which is stored in a particular position on the tool table. Each of anvils 162 may correspond to the type or configuration of workpiece 100; or some or all of anvils 162 may be generic to all workpiece configurations. One or more of anvils 162 are acquired from tool table 138 by first robotic manipulator 130 and relocated one-by-one to the work surface 122, where they are positioned on work surface 122 against peripheral wall 140 in geometrically accurate locations. In other words, in this non-limiting example, the first robotic manipulator 130 has mounted anvils 162 upon the work surface 122 by placing them in abutting contact with peripheral wall 140. Alternatively, or additionally, anvils 162 may be affixed to the work surface 122 via anvil receptors as described below in connection with second embodiment assembly apparatus 220. By either alternative, anvils 162 are thus releasably mountable on work surface 122, and support frame 124 provides support through anvils 162 for the tool head 158 of robotic manipulator 130, 132 that manipulates a tool 160 for performing work on the workpiece 100.

The first robotic manipulator 130, once having positioned the workpiece fixture or adapter 150 on work surface 122, is then articulated to the tool table 138 to place its gripper in its designated position, release it, and engage a manufacturing tool head 158. Alternatively, optional second robotic manipulator 132, once having positioned workpiece 100 on workpiece fixture or adapter 150, may then be articulated to the tool table to place gripper 154 in its designated position, release it, and engage a manufacturing tool head 158. Each tool head 158 may be one of a plurality of different types, sizes and capacities. In this example, tool head 158 is a press ram type head 158a or a torquing type head 158b, which respectively drive an interfitted tool 160 linearly (in the case of tool head 158a) or linearly and rotationally (in the case of tool head 158b), relative to the workpiece 100 when installing a component part 104.

The interfitted tool 160a, 160b of each respective type of tool head 158a, 158b is one of a plurality of interchangeable tools 160a, 160b, 160c, 160d, each having a particular storage position on tool table 138, and the robotic manipulator with tool head 158a or 158b attached thereto, is articulated to acquire and interfittingly engage one of interchangeable tools 160 appropriate for the component part 104 to be installed on workpiece 100. Alternatively, tool 160 may be the sole tool 160a or 160b used with the respective type of tool head 158a or 158b, and may remain interfittingly engaged with its tool head 158.

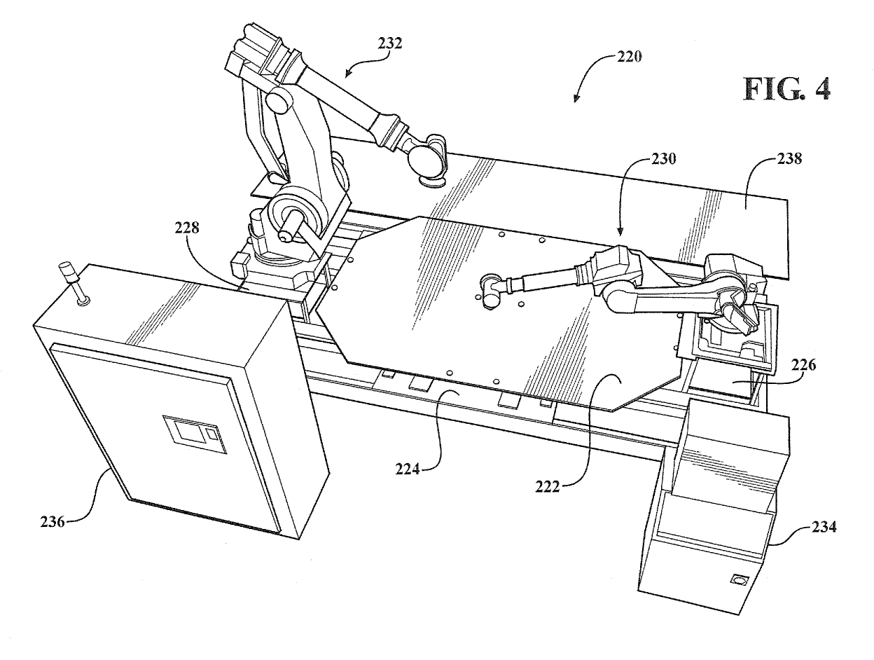

Referring to FIGS. 4-10, alternative second embodiment modular assembly station or apparatus 220 of manufacturing system 110 is shown. Modular assembly station 220 includes work surface 222 mounted upon frame 224. First and second manipulator platforms 226, 228 are disposed on opposite sides of and adjacent to the work surface 222. Each of the platforms 226, 228 is also mounted to the frame 224.

A first robotic manipulator 230 is mounted upon the first manipulator platform 226 and a second robotic manipulator 232 is mounted upon the second manipulator platform 228. Although it is contemplated that each robotic manipulator 230, 232 may have a designated task in carrying out the manufacturing operations on workpieces 100a, 100b, it is preferred that the robotic manipulators 230, 232 each be able to perform some if not all of the robotic manufacturing operations within assembly station 220. Robotic manipulators 230, 232 are controlled by controller 234 and electronics panel 236 in a manner well known to those of ordinary skill in the art.

A tool table 238 is also mounted on the frame 224, adjacent to the work surface 222. The tool table 238, work surface 222, and robotic manipulators 230, 232 are each arranged in a geometrically accurate location, as are component part receiving stations 270, which are substantially identical to receiving stations 170 of assembly apparatus 120.

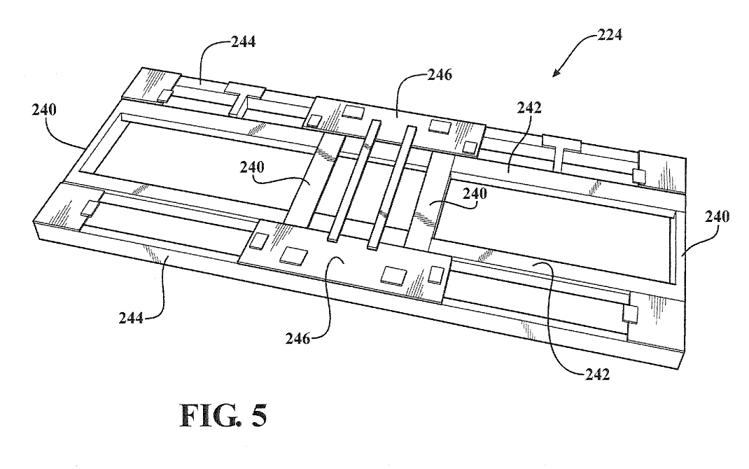

Referring to FIG. 5, frame 224 includes width-wise cross members 240 and length-wise cross members 242 to provide support for the work surface 222 and the first and second manipulator platforms 226, 228 as necessary. The width-wise cross members 240 are connected to the length-wise cross members 242 and to longitudinal rails 244 via intermediate walls 246.

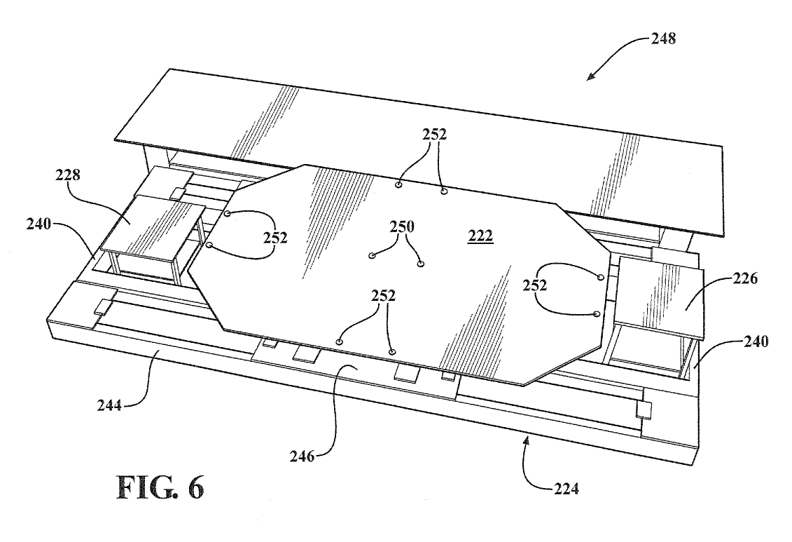

Referring now to FIG. 6, a subportion of the assembly apparatus 220 is generally shown at 248. Workpiece fixture or registry receptors 250 are centrally located on the work surface 222. Receptors 250 are geometrically located in a dimensionally accurate location. Likewise, anvil receptors 252 are spaced around the work surface 222 in a geometrically accurate location relative to the registry receptors 250. Each of the receptors 250, 252 can be adapted to engage the workpiece fixture registry or the anvils in response to pneumatic, electrical, or electronic inputs, and thereby secure the registry and anvils to the work surface 222. Further, the registry and registry receptors 250 may be adapted to actuate adapter or workpiece fixture 256 for engagement of the workpiece 100 in response to a pneumatic, electrical, or electronic output from the registry, the output being produced in response to registry input from the receptor 250.

Moreover, it is envisioned that registry receptors 250 in particular may be utilized to conduct fluid to and from the workpiece, and/or to provide electrical instrumentation connections, for conducting post-assembly process leak tests within assembly apparatus 220. Additionally, various other ports (not shown) may be used to provide inputs at desired locations in work surface 222.

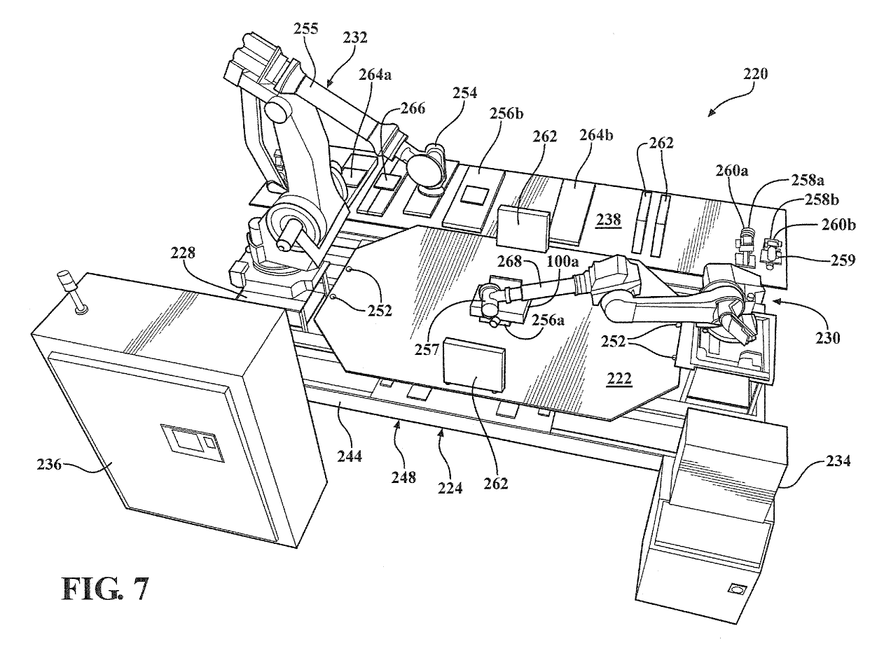

FIG. 7 shows the modular assembly apparatus 220 preparing to perform a manufacturing operation on a workpiece 100. The workpiece 100 arrives at delivery station 114 on workpiece conveyor 112 (FIG. 1), and is known to be, or is there sensed as being a particular one of the plurality of different workpiece configurations 100a, 100b. In this non-limiting example, workpiece fixtures or adapters 256a and 256b, which are particularly configured to support their respective workpieces 100a and 100b, are stored in their respective, geometrically accurate positions on tool table 238. An adapter 256 corresponding to the type or configuration of the present workpiece 100 is acquired from tool table 238 by first robotic manipulator 230 using its robotic gripper 257, and relocated to the work surface 222, where it is secured in a geometrically accurate location to the work surface 222 directly or through an intermediate registry, via registry receptors 250.

The workpiece 100 is grasped by the second robotic manipulator 232 using its robotic gripper 254, which is removably attached to the end of the robot's boom 255, and relocated from delivery station 114 to assembly station 220. The second robotic manipulator 232 delivers the workpiece 100 to the workpiece fixture or adapter 256 that is mounted to the work surface 222. In a known manner, electronic or pneumatic inputs are provided through the work surface 222 and registry, to the workpiece fixture or adapter 256, to actuate locking devices (not shown) in the workpiece fixture or adapter 256. These locking devices secure the workpiece 100 to the workpiece fixture or adapter 256, and thus to work surface 222, in a geometrically accurate location.

In this non-limiting example, the first robotic manipulator 230 is articulated to the tool table 238, and using gripping device 257 grasps one of a plurality of anvils 262, each of which is stored in a particular position on the tool table. Each of anvils 262 may correspond to the type or configuration of workpiece 100; or some or all of anvils 262 may be generic to all workpiece configurations. One or more of anvils 262 are acquired from tool table 238 by first robotic manipulator 230 and relocated one-by-one to the work surface 222, where they are secured in a geometrically accurate location to the work surface 222 via anvil receptors 252. In this non-limiting example, the first robotic manipulator 230 has installed anvils 262 upon the work surface 222 via anvil receptors 252, although one of ordinary skill in the art will recognize that second robotic manipulator 232 may perform this function using its gripper 254.

The first robotic manipulator 230, once having positioned the workpiece fixture or adapter 256 and anvils 262 on work surface 222, is then articulated to the tool table 238 to place gripper 257 in its designated position, release it, and engage a manufacturing tool head 258. Alternatively, second robotic manipulator 230, once having positioned workpiece 100 on workpiece fixture or adapter 256, may then be articulated to the tool table to place gripper 254 in its designated position, release it, and engage a manufacturing tool head 258. Each tool head 258 may be one of a plurality of different types, sizes and capacities. In this example, tool head 258 is either a press ram type head 258a or a torquing type head 258b, which respectively drive an interfitted tool 260 linearly and/or rotationally relative to the workpiece 100 when installing a component part 104.

The interfitted tool 260a, 260b of each respective type of tool head 258a, 258b may be one of a plurality of interchangeable tools (such as tools 160a-d described above) having a particular storage position on tool table 238, and the robotic manipulator (e.g. 230) with tool head 258a or 258b attached thereto, is articulated to acquire and interfittedly engage a suitable interchangeable tool 260 (for example, such as one of tools 160a-d described above). Alternatively, tool 260 may be the sole tool 260a or 260b used with the respective type of tool head 258a or 258b, and may remain interfittingly engaged with its tool head 258, as shown in FIGS. 7-10.

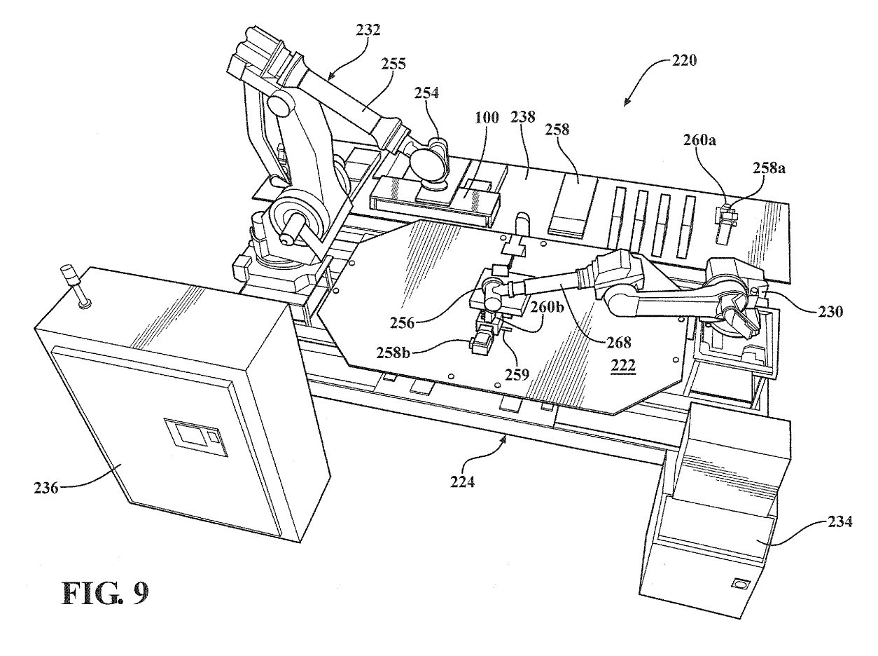

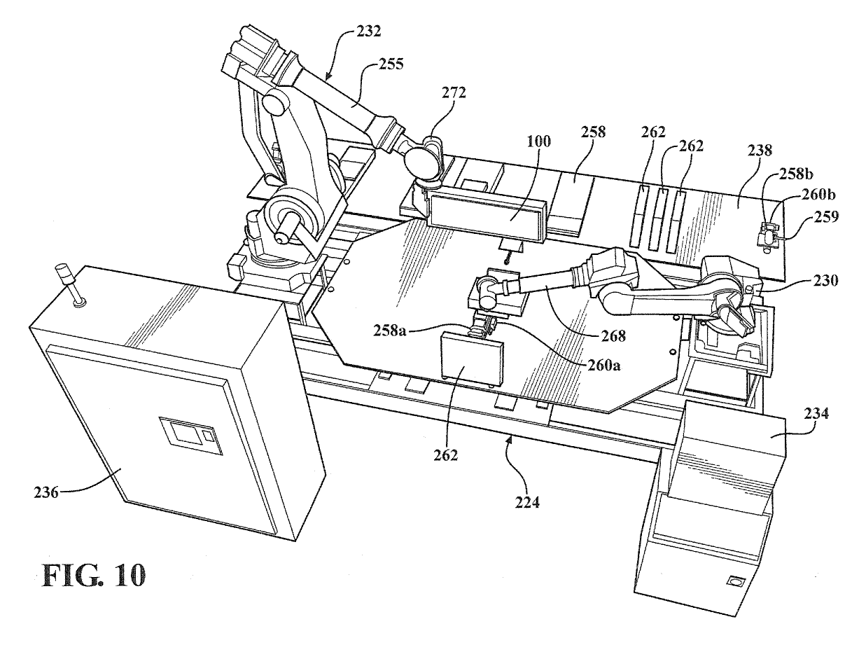

FIGS. 9 and 10 show various tools used to perform manufacturing work on a workpiece 100. FIG. 9 shows the second robotic manipulator 232 moving a workpiece 100 from delivery station 114 to a workpiece fixture or adapter 256 mounted on the work surface 222. The first robotic manipulator 230 is shown with torquing tool head 258b coupled to its boom 268. Alternatively, first robotic manipulator 230 with gripping device 257 may be used for acquiring and affixing an anvil 262 to the work surface 222. FIG. 10 shows one anvil 262 that has been mounted to the work surface 222 by the first robotic manipulator 230, which now has press ram tool head 258a attached to its boom 268. FIG. 10 shows an alternative gripping device 272 affixed to the second robotic manipulator 232, which can be used instead of gripping device 254 for grasping an alternative type of workpiece 100 if its configuration differs sufficiently from the other type of workpieces. In this example, the alternative gripping device 272 is normally stored on the tool table 238 and is interchanged by the second robotic manipulator 232.

Regardless of whether manufacturing system 110 includes first or second embodiment modular assembly station or apparatus 120 or 220, the robotic manipulator to which the tool head 158, 258 is releasably coupled preferably obtains the respective component part 104 from its component part receiving station 170, 270 which may be connected to optional automated component part feed system 310.

The tool 160, 260 with which a particular component part 104 is obtained from its receiving station 170, 270 is adapted to engage and retain the component part 104 (for example, by an interference fit or a spring clip), and hold it securely in a particular orientation relative to the tool head 158, 258 as the tool head is moved with component part 104 attached to tool 160, 260. The tool head 158, 258 is moved from receiving station 170, 270 and positioned proximate to workpiece 100 with component part 104 axially aligned with workpiece aperture or hole 106a, 106b.

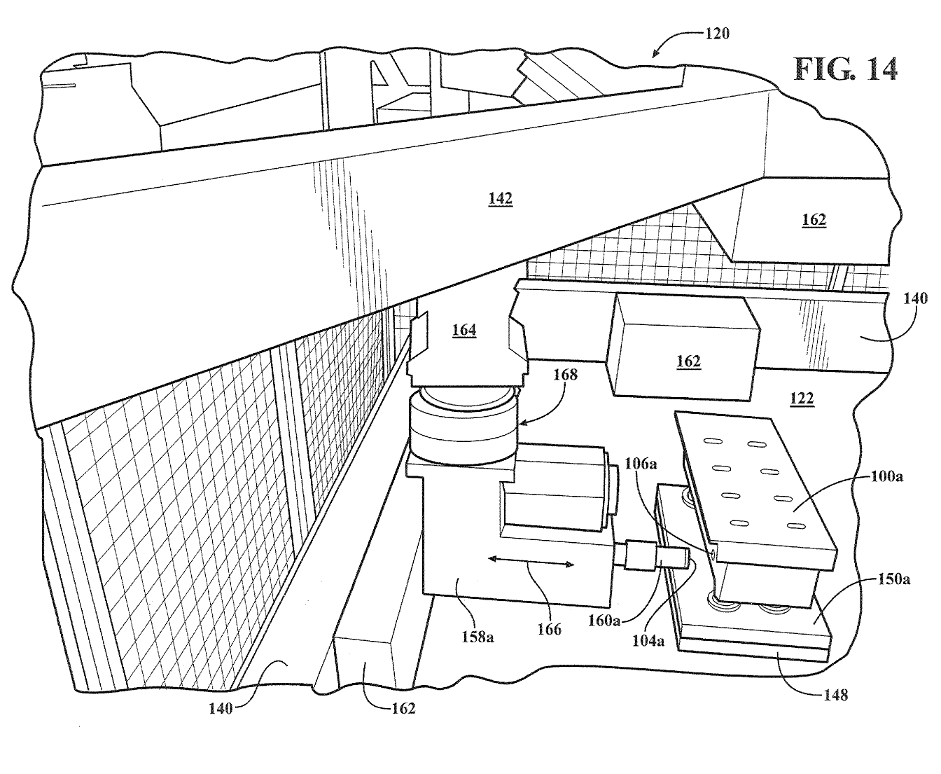

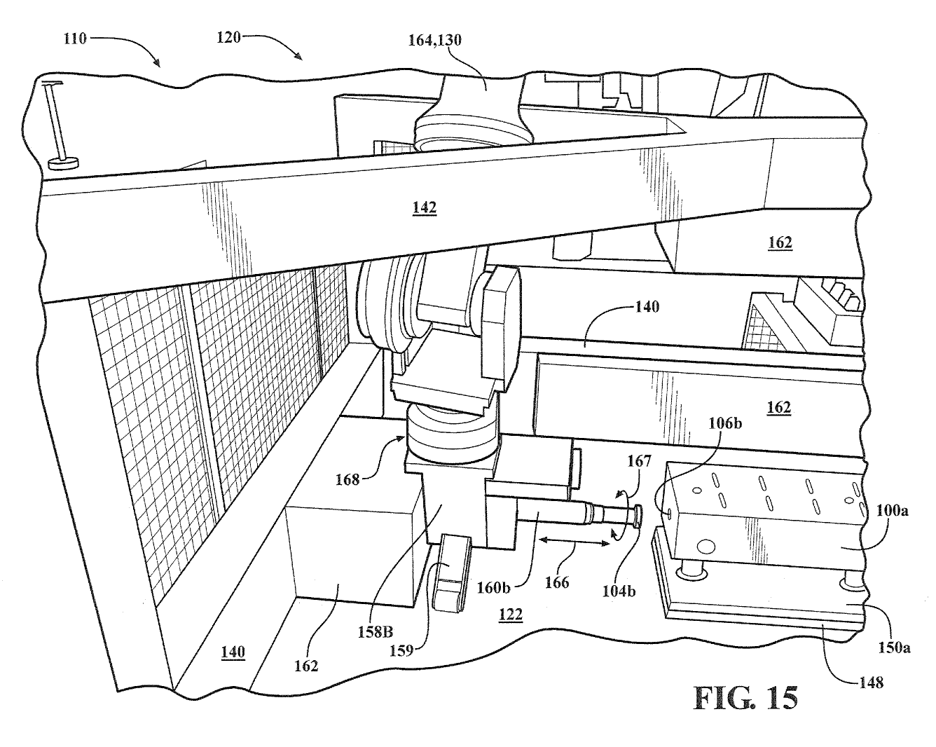

With reference to FIGS. 14 and 15, to reduce the amount of strain known to damage and wear out joints of robotic manipulators, the tool head may be brought into abutting contact with the anvil 162, 262 that corresponds with the aperture or hole 106a, 106b. The tool head 158, 258 is positioned such that tool 160, 260 and its retained component part 104 are aligned with aperture 106a or threaded hole 106b in workpiece 100. That is, the robotic manipulator will position its attached tool head 258 into abutment against the surface of the anvil 262 that is in interfacing relationship with the aperture 106a or threaded hole 106b in workpiece 100 into which component part 104 will be fitted. Once so positioned and abutting anvil 162, 262, tool head 158, 258 is preferably unlocked relative to robotic manipulator boom such that it is unrestrained, and permitted to float relative to the boom, in the axial directions along which tool 160, 260 is linearly stroked in moving towards and away from workpiece 100, as indicated by arrow 166 in FIGS. 14 and 15, for example. The distance of the linear stroke may, for example, be from 0.5 inch to five inches. A press ram tool head 158a, 258a may, for example, be of known servomotor or hydraulic type, the latter suitably provided with fluid fittings, lines, and a controlled source of hydraulic fluid. A torquing tool head 158b, 258b may, for example, be of known pneumatic or electronic type.

The anvil 162, 262 provides an axial reaction surface against which tool head 158 bears as the component part 104 is forced axially into or toward the workpiece 100, this is particularly important where press ram tool head 158a, 258a is being used, as depicted in FIG. 14, which may induce a pressing force of about 1500 pounds in installing a component part 104 (e.g., an interference-fitted plug) into a bore 106a in workpiece 100. It is believed that a torque head 158b, 258b, such as depicted in FIG. 15, will not require the use of an anvil 162, 262 as shown for creating an axial reaction surface during a screwing operation; thus the use of an anvil 162, 262 with a torque head 158b, 258b is considered to be optional and not required for screwing operations. Referring to FIGS. 9 and 15, a torquing tool head such as 158b or 258b may include a laterally extending outrigger 159, 259, the foot or terminal end of which is in abutting contact with work surface 122, 222 which serves as a reaction surface that torsionally supports the tool head 158b, 258b to counteract the tightening torque of the rotating tool 160, 260 as its threaded component part 104 is tightened into threaded hole 106b in workpiece 100.

Once work by a particular tool head or its tool has been performed upon the workpiece 100, the tool head 158, 258 is moved by the robotic manipulator to the tool table 138, 238, where the tool 160, 260 is returned to its designated place on tool table and another tool, or tool head and tool, acquired as applicable. If a different tool head 158, 258 and/or tool 160, 260 is acquired a different component part 104 may be acquired from its respective receiving station 170, 270 and processing of workpiece 100 continues.

When all of the work operations have been completed upon the workpiece 100, the workpiece 100 is removed from the work surface 122, 222 by a robotic manipulator and returned to delivery station 114 or transferred to another conveyance, assembly line or dunnage as described above.

In some instances, it is necessary to test the workpiece 100 for leaks. It may be preferable that leak testing be done in assembly apparatus 120, 220, prior to removing the workpiece 100 from system 100 after completion of the manufacturing operation. One example is for an engine block or cylinder head workpiece (e.g., workpiece 100) that has undergone the assembly process in apparatus 120, 220 to be sealed and internally provided with pressurized fluid to verify that the installed component parts 104 (e.g., plugs or sensors) are dimensionally accurate and correctly seal fluid passages in the workpiece. Therefore, the work surface 122, 222 may by adapted to receive assembly apparatus leak test components to ensure the fluidic integrity of the workpiece 100. Such further processing may be done by a manufacturing system 110 utilizing either assembly apparatus 120 or 220, but the example below is described with respect to the latter.

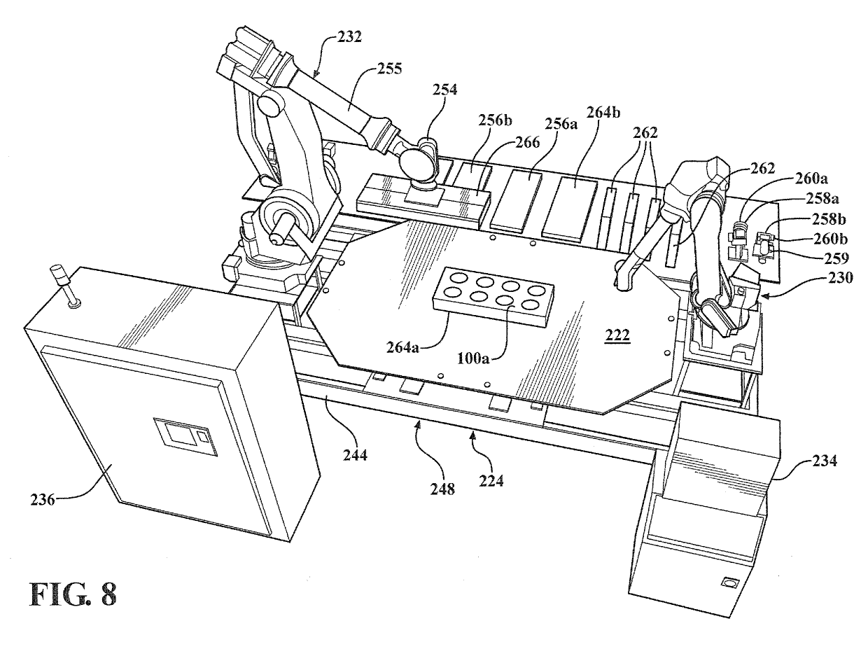

A seal plate 264 is stored on tool table 238. Referring to FIG. 8, after workpiece 100 has completed its manufacturing operations (e.g., the installation of component parts 104), it is removed from its workpiece fixture or adapter 256, and its workpiece fixture or adapter 256 is removed from its registry, and registry then removed from the work surface 222. A seal plate 264 is mounted onto work surface 222 through engagement with registry receptors 250. Seal plate 264 is configured to accommodate the particular configuration of workpiece 100, and so a seal plate 264a may be provided for leak testing workpiece 100a, and a seal plate 264b may be provided for leak testing workpiece 100b. Workpiece 100 is then placed on seal plate 264, and, if necessary, acts as a manifold for receiving or routing pneumatic or hydraulic pressure received through work surface, to internal passages of workpiece 100. Seal plate 264 may include locking devices (not shown) similar to those of workpiece fixture or adapter 256 for engagement with workpiece 100. Workpiece 100 is thus fixed through seal plate 264 to work surface 222.

A longitudinal leak test seal plate 266, which may be common for use with both workpiece configurations, is stored on the tool table 238. Still referring to FIG. 8, longitudinal leak test seal plate 266 is moved by the second robotic manipulator 232 from the tool table 238 and placed atop the workpiece 100 and seal plate 264. The longitudinal leak test seal plate 266 includes piping and wiring to receive either pneumatic or hydraulic pressure from delivery ports mounted either in the seal plate 264 or on the work surface 222. The wiring may be electrically connected to the electronics panel 236 through electrical connectors (not shown) in the work surface 222 to provide pressure indication readings through the electronics panel 236 to the controller 234 to determine if any leaks exist in the manufactured workpiece 100. Alternatively, mechanical measurements can be made that do not require piping or wiring.

The longitudinal leak test seal plate 266 is secured to the seal plate 264 via a threaded rod (not shown) secured by robotic manipulator 230, a torquing tool head and a torquing tool such as head 258b and tool 260b. Once seal plate 266 is secured over ports in workpiece 100, pressured fluid is conducted through seal plate 264 to workpiece 100, which is checked for leaks indicated by sensed pressure changes therein. It should be understood by those of skill in the art that alternative leak test seal plates may be required to conduct a leak test of various, differently configured workpieces 100.

Manufacturing system 110 may include automated component part feed system 310 optionally connected to modular assembly apparatus or station 120 or 220. Feed system 310 supplies assembly stations 120, 220 with a plurality of different component part types 104, at least one of the plurality of different component parts 104 assembled to one or both types of workpieces 100a, 100b.

The automated component part feed system 310 includes a workstation 312 for separating and identifying a plurality of different types of component parts 104a-d and for moving the component parts 104 to the respective dispatching station 314a-d of the appropriate dispatching lane 316a-d. One type of the component part 104a, 104b, 104c, or 104d is conveyed from component part feed system 310 to assembly apparatus 120, 220 by the associated one of the dispatching lanes 316a-d extending therebetween, as discussed further below. The component parts 104 can be washers, screws, bolts, sprockets, gears, plugs, sensors or any other suitable type of component part for the product produced by manufacturing system 110, one or more of component parts 104a-d being assembled in assembly station or apparatus 120, 220 to at least one of workpieces 100a and 100b. Generally, the component parts 104 are threadedly attached or inserted/pressed into a workpiece 100 at assembly station 120, 220.

The workstation 312 includes a hopper 318 and a conveyor 320 in communication with the hopper 318. The hopper 318 receives all of the parts 104 and the conveyor 320 moves the parts 104 away from the hopper 318. More specifically, the hopper 318 receives a plurality of differently configured types of component parts 104 thus eliminating the need for multiple hoppers and multiple conveyors as required by the prior art. The hopper 318 defines a top opening 322 into which are dumped or poured component parts 104. Component parts of a single type 104a, 104b, 104c, or 104d may be dumped together into hopper 318, or a mixture of two or more different types of component parts 104a-d may be dumped together into hopper 318. The hopper 318 also defines a bottom opening 324 spaced from the top opening 322 and aligned with the conveyor 320 for moving the component parts 104 from the hopper 318 and onto the conveyor 320. The hopper 318 is preferably positioned above the conveyor 320 such that the parts 104 coming out of the bottom opening 324 do not overlap each other on the conveyor 320. The hopper 318 also includes a vibration or oscillation mechanism (not shown) for aiding in moving the component parts 104 through the bottom opening 324. The vibration or oscillation mechanism causes the hopper 318 to vibrate, pulse, shake, beat, tip or any other suitable movement for moving the parts 104 through the hopper bottom opening 324 and onto conveyor 320.

The conveyor 320 includes a distal end 326 and a proximal end 328 spaced from each other with the hopper 318 disposed adjacent the proximal end 328 of the conveyor 320. The hopper 318 cooperates with the conveyor 320 for moving the parts 104 from the proximal end 328 toward the distal end 326. The conveyor 320 includes a longitudinally moveable endless belt 330 rotating around the proximal and distal ends 328, 326 for continuously moving the parts 104 received from the hopper 318 toward the distal end 326. One of ordinary skill in the art will appreciate that the conveyor 320 can include chain links or any other suitable component other than a belt 330 for moving the parts 104 toward the distal end 326.

The conveyor 320 further includes opposing side rails 332 extending vertically between the hopper 318 and the conveyor 320, and horizontally between the conveyor proximal and distal ends 328, 326. The side rails 332 are laterally spaced from each other and are angled inwardly or convergent toward the distal end 326 of the conveyor 320 for guiding the component parts 104 together as they approach the distal end 326. The ends of converging sidewalls 332 are spaced near conveyor distal end 326 to define an outlet opening 340 from which the various component parts 104 emerge in a random, single file order. That is, each of component parts 104a-d individually passes through outlet opening 340 continues in a single file line of parts 104 on belt 330 toward distal end 326. More specifically, the side rails 332 are spaced a first predetermined distance from each other adjacent the hopper 318 and the side rails 332 are spaced a second predetermined distance from each other adjacent the distal end 326. The second predetermined distance, which defines outlet opening 340, is less than the first predetermined distance such that the component parts 104 are funneled into single file line on belt 330 at the conveyor distal end 326.

The automated component part feed system 310 further includes a component part robotic manipulator 334 movable along a track 336 for acquiring each of the component parts 104 from the distal end 326 and moving it away from the conveyor 320. The component part robotic manipulator 334 includes a gripping device 335 for gripping each and any of component parts 104a-d, and moving it from distal end 326 to the appropriate dispatching station 314a-d associated with a respective one of dispatching lanes 316a-d, one at a time. Gripping device may also adjust the position of a component part as necessary, such that it can grip each type of component part 104 in a consistent manner for placement in its dispatching station. More specifically, the gripping device 335 picks up one of the component parts 104 from the distal end 326 of the conveyor 320 and places that component part 104, in a proper orientation, in the respective dispatching station 314 for transference via dispatching lane 316 to the assembly apparatus 120, 220. The component part robotic manipulator 334 can be controlled by controller 348 and electronics panel 350, in a manner well known to those of ordinary skill in the art.

In one embodiment of component part feed system 310, distal end 326 may be provided with a moving inspection platform 344, which may be defined by a second conveyor belt that is independently moveable longitudinally relative to belt 330. In an alternative embodiment, the belt 330 of the conveyor 320 can be periodically stopped for allowing the identifier 338 to identify the parts 104, the end of belt 330 serving as the inspection platform 344. Regardless of component part feed system embodiment, inspection platform 344 supports the component part 104 for inspection by an identifier 338 and acquisition by robotic manipulator gripping device 335. The identifier 338, which may be a camera or other digital imaging device, is disposed adjacent the distal end 326 of the conveyor 320, above the inspection platform 344 for determining the type of component part 104 being inspected, and whether that part 104 requires reorientation before it is acquired by the gripping device 335 and moved to the appropriate dispatching station 314. More specifically, the identifier 338 scans the component part 104 located on platform 344 to identify its type, size and/or orientation, and communicates information regarding the present component part 104 to the component part robotic manipulator 334, which then repositions the component part 104 as necessary, acquires the component part 104 with its gripping device 335, and moves laterally along track 336 with the gripped component part 104 to relocate it from the inspection platform 344 to the appropriate one of dispatching stations 314a-d.

In preferred embodiments of component part feed system 310, the identifier 338 can be coupled to the conveyor 320 and/or coupled one or more of the side rails 332 and/or coupled to the track 336 and/or coupled to the component part robotic manipulator 334. When the identifier 338 is disposed on the component part robotic manipulator 334, the identifier 338 will be disposed adjacent the distal end 326 when the component part robotic manipulator 334 moves along track 336 to align itself with the longitudinal axis of conveyor belt 330 or inspection platform 344. The identifier 338 eliminates the need to have multiple hoppers, multiple conveyors and multiple robotic manipulators as required by prior art component part feed systems. The identifier 338 can be defined as a camera or any other suitable mechanism for identifying the component parts 104.

In alternative embodiments of component part feed system 310, the component part robotic manipulator 334 holds one of the component parts 104 under the identifier 338 for identifying the part 104. In yet another embodiment, the component part robotic manipulator 334 relocates each component part 104 from the conveyor 320 to a separate, stationary surface 346 for identification by the identifier 338 of the present part 104 and any necessary repositioning thereof. On surface 346, which may serve as inspection platform 344, the orientation of the identified part 104 is adjusted as necessary by component part robotic manipulator 334 prior to subsequent relocation to a dispatching station 314.

Each of the dispatching stations 314 associated with a dispatching lane 316 receives one type of the component parts 104. More specifically, one dispatching station 314 and its dispatching lane 316 is dedicated to receiving one of the different types of component parts 104a-d and another dispatching station 314 and associated dispatching lane 316 is dedicated to receiving a different one of the types of the plurality of component part types 104a-d, etc., as mentioned above. For example, two different component parts 104 can be further defined as a first part type 104a and a second part type 104b, with the identifier 338 identifying or distinguishing the first part type from the second part type. The identifier 338 communicates the first and second part types 104a, 104b to the component part robotic manipulator 334 such that the component part robotic manipulator 334 moves along track 336 to relocate the first part type 104a from inspection platform 344 to first dispatching station 314a which is in communication with a first dispatching lane 316a; and moves along track 336 to relocate the second part type 104b from inspection platform 344 to second dispatching station 314b which is in communication with a second dispatching lane 316b. It is to be appreciated that the component parts 104 can be further defined as including a third part type 104c and a fourth part type 104d, etc., which are respectively fed to assembly apparatus 120, 220 by component part feed system 310 via their respective dispatching stations 314c, 314d and dispatching lanes 316c, 316d, without deviating from the subject invention.

The dispatching lanes 316 are spaced from each other such that the component part robotic manipulator 334 is disposed between the conveyor 320 and the dispatching lanes 316 with the dispatching lanes 316 disposed between the component part robotic manipulator 334 and the assembly apparatus 120, 220. Therefore, the gripping device of the component part robotic manipulator 334 takes one of the component parts 104 from the conveyor 320 and places that particular component part 104 in the dispatching station 314 of the appropriate dispatching lane 316 for delivering the part 104 to the component part receiving station 170, 270 of assembly apparatus 120, 220, to perform the manufacturing operation on the workpiece 100. The component part robotic manipulator 334 moves back and forth along the track 336 and places the parts 104 in the respective dispatching stations 314 of the appropriate dispatching lanes 316 and in the appropriate orientation, thus eliminating the need for skilled laborers to move the component parts 104 to the appropriate dispatching lanes 316 and properly orientating the component parts 104. Component part receiving stations 170, 270, dispatching stations 314, and dispatching lanes 316, are of a type known to those of ordinary skill in the art, and are specially designed as a part feeder set for a specific component part having a particular size, configuration and/or type. A part feeder set for component part 104a may include, for example, associated receiving station 170a, 270a, dispatching station 314a, and dispatching lanes 316a, . . . etc. . . . A receiving station, dispatching station, and dispatching lane set, or a plurality of such part feeder sets, may be of a general type that may be designed and manufactured for, and supplied to, assemblers of workpieces 100 by any of a number of sources such as, for example, Spectrum Automation Company of Livonia, Mich.; Air Way Automation, Inc. of Grayling, Mich.; or Visumatic Industrial Products of Lexington, Ky. Briefly, by way of example, the part feeder set may be of a type in which component parts 104 are blown by compressed air, one at a time, through dispatching lane 316 from its dispatching station 314 towards its associated receiving station 170, 270. A buffer of a plurality of identical component parts may be accumulated in the end of dispatching lane 316 adjacent receiving station 170, 270, ready for use by assembly apparatus 120, 220.

Alternatively, the part feeder set may be of a type in which a pneumatic cylinder urges a component part 104 newly inserted into a dispatching station 314 into its dispatching lane 316, the newly inserted component part forming the end of a stack of component parts 104 that extends along the length of dispatching lane 316, the component part at the opposite end of the stack located in receiving station 170, 270. These component parts are moved in daisy chain fashion through the dispatching lane as the most recent addition to the stack is moved by the pneumatic cylinder, and are continuously supplied to receiving station 170, 270 for ready use by assembly apparatus 120, 220.

For illustrative purposes only, the operation of the automated component part feed system 310 is discussed below. First, multiple different types of the parts 104 are poured into the top opening 322 of the hopper 318. The oscillation mechanism vibrates the hopper 318 which in turn vibrates the parts 104 for aiding in moving the parts 104 out of the bottom opening 324 of the hopper 318 and onto the belt 330 of the conveyor 320. The parts 104 move from the proximal end 328 toward the distal end 326 of the conveyor 320 with the side rails 332 guiding the parts 104 into single file. As each part 104 reaches the identifier 338, the identifier 338 determines the type of the part 104 and whether the part 104 requires reorientation. The identifier 338 communicates this information to the component part robotic manipulator 334, which travels along the track 336 to align itself with the conveyor 320 such that the gripping device can pick up that particular component part 104. Once the gripping device is gripping that particular part 104, the component part robotic manipulator 334 travels along the track 336 again and aligns itself with the appropriate dispatching station 314 to release that particular part 104. The gripping device 335 then places the component part 104 in the dispatching station and in the appropriate orientation. The component part 104 then travels down the dispatching lane 316 to its connected receiving station 170, 270 of assembly apparatus 120, 220, which performs the manufacturing operation that assembles the component part 104 to workpiece 100. The component part robotic manipulator 334 repeats the process of picking up the component parts 104 and moving those component parts 104 to the appropriate dispatching station 314.

While the invention has been described with reference to exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A manufacturing system including an apparatus in which a plurality differently configured workpieces requiring manufacturing operations are processed, the apparatus comprising:
a work surface configured to receive apparatus components and a plurality of differently configured workpieces, said work surface configured to support the apparatus components and the plurality of differently configured workpiece in geometrically accurate locations;
a tool table adjacent said work surface providing support for tooling and apparatus components required to process various manufacturing operations on the workpieces; and
a first robotic manipulator positioned adjacent to said work surface and said tool table and having a gripping device configured to grip at least one of the apparatus components, said at least one of apparatus components moved by the first robotic manipulator between said tool table and said work surface;
wherein said first robotic manipulator is programmed to selectively acquire tooling from said tool table to perform manufacturing operations on the plurality of differently configured workpieces.

2. The apparatus set forth in claim 1, wherein the work surface has a plurality of receptors configured to receive apparatus components and a plurality of differently configured workpieces, said receptors being configured to support the apparatus components and each of the plurality of differently configured workpiece in a geometrically accurate location.

3. The apparatus set forth in claim 1, wherein said first robotic manipulator positioned has a gripping device configured to grip at least one of the plurality of differently configured workpieces and move it relative to the work surface.

4. The apparatus set forth in claim 1, further comprising a second robotic manipulator positioned adjacent to said work surface and having a gripping device configured to grip at least one of the plurality of differently configured workpieces and move it relative to the work surface.

5. The apparatus set forth in claim 1, wherein said apparatus components comprise an anvil releasably mountable to said work surface, said robotic manipulator supported by at least one of said anvil and said work surface during performance of a manufacturing operation of a workpiece.

6. The apparatus set forth in claim 1, wherein said work surface includes receptors configured to receive a fixture to retain a workpiece in a geometrically accurate location.

7. The apparatus set forth in claim 1, wherein said work surface includes receptors configured to receive a seal test fixture, the apparatus configured to perform sealability testing of a workpiece mounted to said seal test fixture and provided with pressurized fluid through said work surface.

8. The apparatus set forth in claim 1, wherein said work surface includes fluid and electrical connectors to provide and least one of pneumatic, hydraulic and electrical service to at least one said apparatus component.

9. The apparatus set forth in claim 1, further including a controller electronically interconnected to said robotic manipulator, control input to said robotic manipulator provided by said controller.

10. The apparatus set forth in claim 1, further including a controller electronically interconnected with said work surface, control input to and control output from a said apparatus component, respectively provided or received by said controller as necessary to perform manufacturing operations on a workpiece.

11. The apparatus set forth in claim 1, further including a second robotic manipulator cooperating with the first robotic manipulator for transporting and operating apparatus components, tooling, or one of the plurality of differently configured workpieces.

12. The apparatus set forth in claim 1, further including a plurality of walls disposed about the work surface, and against which an apparatus component is supported during a manufacturing operation on a workpiece mounted to a location said work surface, said walls each moveable relative to said work surface location between different positions at which said each wall is fixed relative to said work surface.

13. The apparatus set forth in claim 1, further including a component part supply from which said first robotic manipulator obtains a component part on tooling attached thereto, the first robotic manipulator adapted to install the obtained component part in the workpiece supported by said work surface.

14. A method of assembling first and second differently configured workpieces, comprising the steps of:
releasably affixing first assembly apparatus components to a work surface using at least one of a plurality of receptors positioned in a geometrically accurate location;
releasably affixing the first workpiece to the work surface using at least one of the plurality of receptors thereby positioning the first workpiece in a geometrically accurate location;
supporting assembly apparatus components necessary to assemble the first workpiece relative to the work surface;
positioning a robotic manipulator carrying tooling necessary to assemble the first workpiece and the first component part relative to the first workpiece;
supporting tooling necessary to assemble the first workpiece against undesired movement relative to the first workpiece with at least one of an assembly apparatus component and the work surface;
performing a first assembly operation by operating said tooling and installing the component part to the first workpiece;
removing the first workpiece from the work surface;
releasably affixing second assembly apparatus components to the work surface using at least one of the plurality of receptors positioned in a geometrically accurate location;
releasably affixing the second workpiece to the work surface using at least one of the plurality of receptors thereby positioning the second workpiece in a geometrically accurate location;
supporting assembly apparatus components necessary to assemble the first workpiece relative to the work surface;
positioning a robotic manipulator carrying tooling necessary to assemble the second workpiece and a component part relative to the second workpiece;
supporting tooling necessary to assemble the second workpiece against undesired movement relative to the second workpiece with at least one of an assembly apparatus component and the work surface;
performing a second assembly operation by operating said tooling and installing the component part to the second workpiece; and
removing the second workpiece from the work surface.

15. The method set forth in claim 14, further comprising replacing the tooling used in performing the first assembly operation with interchangeable, different tooling prior to performing the second assembly operation.

16. The method set forth in claim 14, wherein said step of affixing said assembly apparatus components to the work surface is further defined by affixing testing devices to the work surface for testing the workpiece.

17. The method set forth in claim 16, wherein said step of affixing testing devices to the work surface for testing the workpiece is further defined by the steps of:
affixing a leak test plate to the work surface;
affixing the first workpiece to the leak test plate after performing a first assembly operation;
sealing the first workpiece; and
providing fluid under pressure to the sealed first workpiece.

18. The method set forth in claim 14, further including the step of using at least one robotic manipulator for moving the workpieces and the assembly apparatus components to the work surface.

19. The method set forth in claim 14, wherein at least one of said first and second assembly operations include installing differently configured component parts to the first and second workpieces.

20. The method set forth in claim 19, wherein one of said first and second assembly operations includes a pressing operation, and the other includes a screwing operation.

21. An automated feed system for supplying component parts to a manufacturing operation, said feed system comprising:
a hopper for receiving a plurality of differently configured component parts;
a conveyor in communication with said hopper and having a proximal end and a distal end with said hopper disposed adjacent said proximal end with said hopper cooperating with said conveyor for moving the component parts from said proximal end toward said distal end;
opposing side rails extend between said hopper and said conveyor distal end for guiding the component parts toward said distal end;
a robotic manipulator movable along a track for moving the component parts from said distal end and away from said conveyor; and
an identifier disposed adjacent said distal end with said identifier in communication with said robotic manipulator, each of the component parts identified by the identifier.

22. A feed system as set forth in claim 21 further including a plurality of dispatching lanes spaced from each other, each of the identified component parts relocated by the robotic manipulator to an associated dispatching lane from the conveyor distal end.

23. A feed system as set forth in claim 22 wherein the component parts are further defined as a first component part type and a second component part type with said identifier identifying the first component part type from the second component part type and communicating the first and second component part types to the robotic manipulator such that the identified first component part type is moved by the robotic manipulator to one of said dispatching lanes and the identified second component part type is moved by the robotic manipulator to another one of said dispatching lanes.

24. A feed system as set forth in claim 22 wherein said robotic manipulator includes a gripping device by which one of the component parts is grasped and moved by the robotic manipulator to one of said dispatching lanes.
